(19) United States
(12) Patent Application Publication
(10) Pub. No.: US 2006/0099350 A1
(43) Pub. Date: May 11, 2006

(54) Method and apparatus for applying powder in a pattern to a substrate

(75) Inventor: Martin David Hallett, Kent (GB)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: Phoqus Pharmeceuticals Limited, West Mailing, Kent (GB)

(21) Appl. No.: 10/527,482

(22) PCT Filed: Sep. 11, 2003
(86) PCT No.: PCT/GB03/03926

§ 371 Date: Sep. 28, 2005

(30) Foreign Application Priority Data
Sep. 13, 2002 (GB) 0221293.4

(51) Int. Cl. B05D 1/04; B05D 1/32; B05C 11/11; B05B 5/08

(52) U.S. Cl. 427/458; 427/282; 427/2.1; 118/504

(57) ABSTRACT

A method and apparatus for providing a pattern on a solid dosage form, in which powder material is applied in a pattern to a substrate. A mask having an aperture is provided between a source of the powder material and the substrate and the powder material is applied to the substrate through the mask. Relative movement of the substrate with respect to the source of powder material is effected during the pattern application process.

The present application relates to a method and apparatus for the creation of patterns on the surfaces of solid dosage forms by the application of powder material onto the surface of substrates and more particularly, but not exclusively, to the creation of patterns on pharmaceutical solid dosage forms.

A “solid dosage form” can be formed from any solid material that can be apportioned into individual units and is, therefore, a unit dose form. A solid dosage form may be, but is not necessarily, an oral dosage form. Examples of pharmaceutical solid dosage forms include pharmaceutical tablets and other pharmaceutical products that are to be taken orally, including pellets, capsules and spherules, and pharmaceutical pessaries, pharmaceutical bougies and pharmaceutical suppositories. Pharmaceutical solid dosage forms can be formed from pharmaceutical substrates that are divided into unit dose forms. Examples of non-pharmaceutical solid dosage forms include items of confectionery and washing detergent tablets.

The creation of patterns on the surface of solid dosage forms by the application of powder material in a pattern is difficult to achieve in any way that is economical and applicable to mass production. WO 01/43727 describes a method of electrostatically applying a powder material to a solid dosage form, in which charged powder material is applied to a photoconductive drum, is transferred to an intermediate belt and then to a solid dosage form. In that way the material may be applied in a pattern to the solid dosage form. Such a process is able to apply powder material in a wide variety of patterns but requires the use of a photoconductive drum.

The present invention provides a method of providing a pattern on a solid dosage form which comprises application of powder material in a pattern to a substrate, the method comprising the steps:

providing a mask having an aperture between a source of the powder material and the substrate;

applying the powder material to the substrate through the mask;

effecting relative movement of the substrate with respect to the source of the powder material during the pattern application process.

In the method of the invention, the mask prevents application of powder material to all areas of the substrate except those exposed by the aperture. The position of the mask may, for example, remain fixed relative to the source of powder material whilst the position of the substrate in relation to both the mask and the source is varied. In one embodiment the mask is fixed relative to the source of the powder material and the substrate is moved past both the mask and the source of powder material. Relative movement of the substrate past the source of the powder material and the mask has the effect that new areas of the substrate are exposed through the aperture as movement is effected. The position of the mask may, for example, vary relative to the source of powder material. The mask may be moved past the source of powder material at the same speed as the substrate or the mask may move at a different speed to the substrate. In one embodiment both the mask and the substrate are moved past the stationary source of powder material. The movement of the mask may be a reciprocating movement such that the mask moves from, and then returns to, its original position. Generally, the substrate is moved, the source remains stationary and the mask may be fixed or may move. Alternatively, however, the source can be made to travel whilst the substrate remains stationary and the mask may be fixed or may move. A further possibility is that the mask and source may be movable as well as the substrate, provided relative movement of the substrate and the powder source/the mask is ensured.

The relative movement may, for example, be effected continuously during the pattern application process. Alternatively, the relative movement may not be effected continuously through out the pattern application process, for example relative movement may be stopped during powder delivery.

The method of the invention can be used to apply different types of patterns. The term “pattern” is used in a broad sense and includes, but is not limited to, for example, a simple pattern such as a single line or spot, as well as more complex patterns. The term “pattern” should not be construed to be limited to a repetitive arrangement of developed regions on the solid dosage form. The pattern on the solid dosage form may consist of one development of the shape of an aperture, for example a solitary spot.

The present invention further provides an apparatus for providing a pattern on a solid dosage form by application of powder material in a pattern to a substrate, the apparatus including

a source for powder material,

a support assembly for supporting the substrate in the vicinity of the source of the powder material,

a means for applying the powder material to the surface of the substrate,

and a mask with an aperture,

the apparatus being arranged such that, in use, the powder material is applied to the substrate through the aperture in the mask.

The mask may, for example, be fixed relative to the source for powder material whilst the support assembly for the substrate may be mounted for movement relative to both the mask and the source for powder material. The apparatus may, for example, be such that both the support assembly for the substrate and the mask are mounted for movement relative to the source for powder material. The support assembly and the mask may be mounted such that they move at the same speed or at different speeds. The mask may be mounted for reciprocating movement so that the mask moves from, and then returns to, its original position. Generally, the support assembly for the substrate is arranged for movement, the source is arranged to be stationary and the mask may be mounted for movement or be stationary. Alternatively, however, the source may be mounted for movement whilst the support assembly for the substrate is arranged to be stationary and the mask may be mounted for movement or be stationary. A further possibility is that the mask and source may be mounted for movement as well as the support assembly.

Preferably the thickness of the mask is no more than 5 mm, and usually less than 5 mm. More preferably, the thickness of the mask is no more than 2 mm and most preferably the thickness of the mask is no more than 1 mm. If the mask is too thick, the distance between the source of powder material and the substrate may be too great for optimal application of the powder material.

Preferably, the mask is placed such that the surface of the substrate is no more than 5 mm, and usually less than 5 mm, from the surface of the mask during delivery of the powder material. More preferably the distance of the surface of the substrate from the surface of the mask during delivery of the powder material is no more than 2 mm and most preferably the distance is no more than 1 mm. Therefore, it is preferred that the mask is close to the surface of the substrate to ensure that the pattern of the aperture developed on the surface by exposure to the powder material is sharp.

In one embodiment of the invention, the aperture in the mask is round. A round aperture is usually circular, but may be an elliptical or other shape. Alternatively, the aperture may be for example a slit whose length is along the direction of relative movement of the substrate, a slit whose length is perpendicular to the direction of relative movement of the substrate, or a first slit intersected along its length by one or more further slits that extend transversely to the first slit.

Preferably the powder material is applied by electrostatic means.

In one especially preferred method, the powder material is an electrostatically charged powder material applied by electrostatic means comprising

applying a bias voltage to generate an electric field between the source of the powder material and the substrate;

applying the electrostatically charged powder material to the substrate, the powder material being driven onto the substrate by the interaction of the electric field with the charged powder material.

In an especially preferred apparatus of the invention the source for powder material is a source for electrostatically charged powder material and the means for applying the powder material to the surface of the substrate comprises

a voltage source for applying a bias voltage between the source of the powder material and the substrate to generate an electric field therebetween,

the apparatus being arranged such that, in use, the powder material is driven onto the substrate by the interaction of the electric field with the charged powder material.

In one embodiment of the invention, the bias voltage applied is a DC voltage and powder is delivered continuously through the mask. In a different embodiment, the bias voltage applied is a DC voltage in combination with a high frequency AC voltage and powder is delivered continuously through the mask. When powder is delivered continuously through the mask during the pattern application process, movement of the substrate causes the powder to be applied continuously along the surface so that the pattern of the aperture developed on the substrate is streaked over the surface of the substrate. Thus, a line parallel to the movement of the substrate is developed on the surface of the substrate. The thickness of the line depends on the maximum width of the aperture.

In a further embodiment, the bias voltage applied is a low frequency AC voltage and powder is delivered periodically through the mask. The low frequency AC voltage may be applied in combination with a high frequency AC voltage. Periodic delivery of powder to the surface of the substrate during the pattern application process enables regular, discontinuous patterns to be developed. For example, if the aperture is round, a series of spots can be developed on the surface, and if the aperture is a slit a series of lines can be developed on the surface of the substrate.

The lower limit for low frequency AC may be 0.1 Hz. The upper frequency limit of low frequency AC is the frequency above which there is no discernible discontinuous patterning or observable variation in the amount of powder delivered to the surface. The upper frequency limit for low frequency AC may be 100 HZ.

High frequency AC can be defined as being a frequency at which no discernible discontinuous patterning can be observed on the surface of the substrate as a result of periodic development through the mask due to the high frequency signal. The lower limit for high frequency is, therefore, the lowest frequency at which the pattern developed appears to be continuous and there is no observable variation in the amount of powder applied to the surface due to the high frequency AC signal. The lower limit for high frequency AC may be as low as 30 Hz The upper limit for high frequency AC may be 5 kHz.

The dimensions of the developed regions of the pattern are affected by the speed of the relative movement of the substrate, the length of the aperture (“length” in this context being the dimension in the direction of movement) and the duty cycle as well as the frequency of the AC voltage. The spacing between the centres of the developed regions depends solely on the relative speed of the substrate and the frequency of the AC voltage and is given by the equation:

$$S = \frac{V}{f}$$

where S=centre to centre spacing
V=velocity of the substrate
f=AC frequency.

Thus increasing the speed of the substrate increases the centre to centre spacing, and hence the spacing between the edges of the developed region, and increasing the frequency decreases the centre to centre spacing and hence the spacing between the edges of the developed region. However, the edge to edge spacing, rather than the centre to centre spacing will also be determined by the length of the aperture and the duty cycle. For example, the longer the aperture the further the substrate would have to travel relative to the source if it were desired that the subsequent powder delivery did not overlap with the previous one. The duty cycle is the duration of the development pulse in relation to the time lapse between pulses. When the duty cycle is 100%, the development is continuous and when the duty cycle is 0%, there is no development. If the development pulse is relatively short compared to the time lapse between pulses, giving a low duty cycle percentage, the spacing between developed regions will be greater than if the development pulse is long provided that the other factors are not also varied. Thus, the frequency, speed, aperture length and duty cycle can be adjusted with regard to one another to obtain the desired pattern.

The magnitude of the bias voltage controls the intensity of the pattern that is developed. The bias voltage can be adjusted to the appropriate value to generate the desired intensity of the pattern.

The magnitude of the bias voltage may be varied during the pattern application process. Variation of the magnitude of the bias voltage during the process generates a pattern that varies in intensity.

The frequency of the bias voltage may be varied during the pattern application process. Variation of the frequency of the bias voltage effects a variation in the spacings between the regions to which powder is applied.

The magnitude of the voltage may be varied as a constant polarity rectangular wave. This can be achieved, for example, by periodically switching a DC voltage between two values allowing periodic delivery of powder to the surface of the substrate. The voltage may be varied as a constant polarity square wave and the duration of application of the lower voltage may be equal to the duration of application of the higher voltage. Alternatively, for example, the voltage may be varied as a truncated triangular wave wherein the transition between the lower and higher voltage is not abrupt as in a rectangular wave. The low and high voltage values may be fixed during the pattern application process.

If a low frequency AC voltage is applied, the amplitude of the AC voltage may be varied at a frequency that is lower than the frequency of the AC signal. The amplitude of the AC voltage may, for example, be simply periodically switched between zero or a low and a high value. Alternatively, the amplitude of the AC voltage may, for example, be varied as a sine, saw-tooth or other wave.

A low frequency AC voltage may have a high frequency AC voltage combined with it. The high frequency AC voltage may be of smaller or larger amplitude than the main low frequency AC voltage.

In one preferred method of the invention the bias voltage is a constant polarity voltage that is periodically switched between two values and the electrostatically charged powder material comprises two components, the particles of a first component being of one colour and one charge to mass ratio and the particles of a second component being of a different colour and a different charge to mass ratio, the charge to mass ratios being such that only the particles with the lower charge to mass ratio are driven onto the substrate when the voltage is at its lower value and both component particles are driven onto the substrate when the voltage is at its higher value. This method enables a two colour pattern to be created on the substrate during a single application step. The low and high bias voltage are adjusted such that at the low bias voltage the field strength is sufficient to drive only the low charge to mass ratio component onto the surface of the substrate, and at the high bias voltage the field strength is sufficient to drive the high charge to mass ratio component onto the surface of the substrate as well.

Thus, in one preferred embodiment of the invention the electrostatically charged powder material is a two-component powder material, the particles of a first component being of one colour and one charge to mass ratio and the particles of a second component being of a different colour and a different charge to mass ratio.

The mask may be made from an electrically insulating material.

Alternatively, the mask may be made from an electrically conducting material.

In one embodiment, the mask is made from an electrically conducting material and the bias voltage between the source of the powder material and the substrate is a DC voltage, and an AC or DC blocking voltage can be applied to the conductive mask. The mask would then only allow powder to pass through to the surface of the substrate when it was not repelling powder from the source.

In one embodiment of the present invention

the mask has a matrix of dot apertures;

the circumference of each aperture is electrically conductive;

each conductive circumference is electrically insulated from the circumferences of the other dot apertures;

and an AC or DC blocking voltage is used to individually address each circumference.

A printing system can thereby be constructed because the flow of powder through each dot aperture is individually controlled.

The apertures in the matrix may, however, have a shape other than that of a dot, the perimeter of each aperture being conductive.

The method of the invention may further comprise a second application of powder material wherein further powder material is applied in a pattern to the substrate by

placing a mask with an aperture between a source of the powder material and the substrate having a pattern;

applying the further powder material to the substrate through the mask;

effecting relative movement of the substrate with regard to both the source of powder material and the mask.

The mask may be a different mask from the mask used in the first application of powder material, having a different aperture, or may be the same mask, and the mask may be positioned differently in relation to the dosage form. Thus, the further powder material may be applied for example only to areas of the substrate where powder was not applied in the first application. The further powder material and the first powder material applied may be the same or different. For example they may be of different colours, or they may have the same colour.

To facilitate the placing of pattern components at chosen points on the surface of the dosage form a tablet location sensor and development field voltage trigger may be used.

In one embodiment of the present invention, the substrate to which the powder material is applied is the solid dosage form.

In one embodiment of the apparatus of the invention, the support assembly for supporting the substrate is a support assembly for supporting the solid dosage form.

The solid dosage form may contain active material.

The powder material may contain active material. The solid dosage form and/or the powder material may include biologically active material, that is a material which increases or decreases the rate of a process in a biological environment. The biologically active material may be one which is physiologically active.

In one embodiment of the present invention, the solid dosage form is a pharmaceutical dosage form.

The solid dosage form may be an oral dosage form.

The pharmaceutical dosage form may be a tablet.

The substrate may be a substrate that is divisible into dosage unit forms.

In one embodiment, if a mark or pattern is applied to a tablet in one application (one “pass”) using a sufficient quantity of powder (e.g. a water-soluble powder), and then in a subsequent pass another powder (e.g. an insoluble powder) is applied to the tablet, covering only those areas not covered in the first pass, a modified release structure may be produced.

The present invention also provides a method of applying powder material in a pattern to a pharmaceutical substrate that is divisible into unit dosage forms, the method comprising the steps:

providing a mask having an aperture between a source of the powder material and a pharmaceutical substrate;

applying the powder material to the pharmaceutical substrate through the mask;

effecting relative movement of the pharmaceutical substrate with respect to both the source of powder material and the mask during the pattern application process;

and, if desired, dividing the pharmaceutical substrate into unit dosage forms.

The present invention further provides a solid dosage form that has had a pattern provided on it by

providing a mask having an aperture between a source of the powder material and the substrate;

applying the powder material to the substrate through the mask;

effecting relative movement of the substrate with respect to the source of the powder material during the pattern application process.

By way of example, certain embodiments of the invention will now be described with reference to the accompanying drawings, in which:

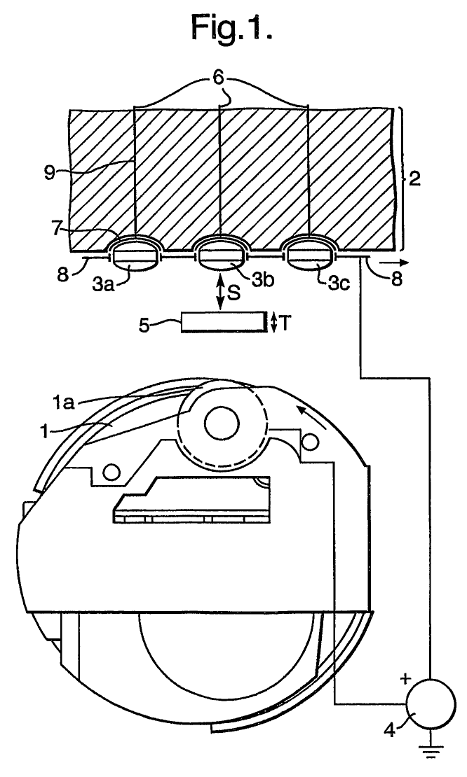

FIG. 1 is a schematic sectional view of an apparatus for electrostatically applying a powder material through a mask to a solid dosage form;

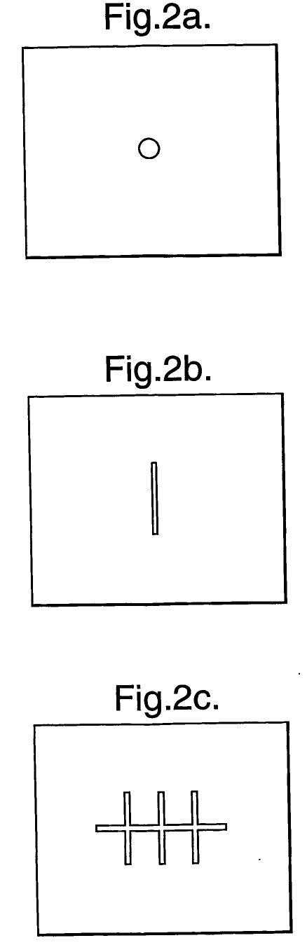

FIG. 2a,2b,2c are schematic plan views of three masks;

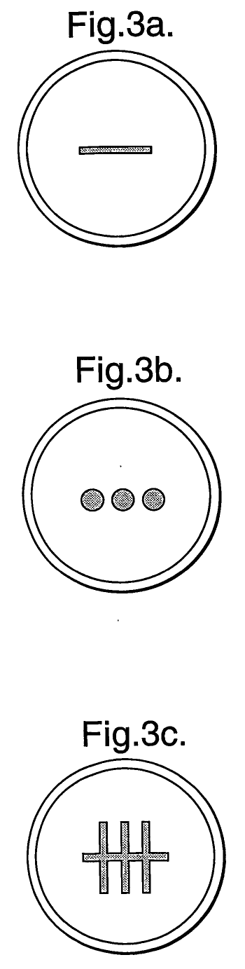

FIG. 3a,3b,3c are schematic plan views of three tablets produced by the method of this invention.

Referring firstly to FIG. 1, the apparatus in this embodiment comprises a source 1 of electrostatically charged powder material, a support assembly 2 for supporting tablets 3, a voltage source 4 and, between the source of the powder material and one of the tablets, a mask 5 with an aperture. FIG. 2 shows three examples of masks with different apertures. The support assembly supports a plurality of tablets and in FIG. 1 three of the patterned tablets 3a, 3b, and 3c are shown. There is a spacing ‘S’ between the surface of the tablet and the mask when the tablet is travelling over the mask and the mask has a thickness ‘T’.

The source 1 of charged powder material includes a roller 1a that is electrically conducting and is connected to the voltage source 4. Powder material in the source 1 is fed to the roller 1a and is charged triboelectrically during its passage to the roller 1a.

The support assembly 2 defines a plurality of tablet receiving stations at each of which a respective tablet 3a, 3b, 3c is received. At each station there is an electrically conducting member 6 which includes a cupped receiving part 7, on which the tablet rests.

It will be noted that in FIG. 1 the tablet is shown on a bottom face of the support assembly 2. It should be understood that the tablet is held on the bottom face against the force of gravity by suitable means, for example by suction (for example, by providing air passageways through the cupped receiving parts 7 and around the stem parts 9 of the conducting members 6 and connecting those passageways to the air inlet side of a vacuum pump).

The voltage source 4 applies a bias voltage to the roller 1a of the source 1 of the charged powder material. The electrically conducting member 6 is earthed. The bias voltage applied by the source 4 can be a steady DC bias voltage, a high frequency AC voltage or a low frequency AC voltage.

In operation of the apparatus, the tablets 3 are moved past the mask 5. The position of the mask and the source of powder material remain fixed. In FIG. 1 the tablet 3b is shown passing over the mask 5 and the source 1 (with the roller 1a and the tablet moving in the directions shown by the arrows in FIG. 1). The bias voltage generates an electric field between the roller 1a and the receiving part 7 of the electrically conducting member 6. The electric field is constant if a DC voltage is applied or oscillating if AC is applied. The electric field causes electrostatically charged powder at the roller 1a to be transferred across to the surface of the tablet through the mask. An electrically conducting shield 8 limits application of the powder to the exposed face of the tablet. Powder is transferred continuously when a DC or a combination of DC and high frequency AC voltage is applied or periodically when a low frequency voltage is applied. The mask prevents application of the powder material to all parts of the tablet except those exposed by the aperture. Only the area on the tablet exposed by the aperture is coated with powder material.

In one embodiment of this invention, the aperture in the mask is circular, as shown in FIG. 2a, and a constant DC voltage is applied to the roller 1a of the source of the powder material. A constant electric field is generated and causes a continuous stream of powder material through the mask to be obtained. The tablet is made to travel past the mask; a speed of for example 25 mm/s is used. The movement of the tablet past the mask causes the powder delivered through the aperture to be streaked over the tablet. The resultant pattern is a stripe parallel to the direction of movement of the tablet as shown in FIG. 3a.

In another embodiment of this invention, the aperture in the mask is circular, as shown in FIG. 2a, and a low frequency AC voltage is applied to the roller 1a of the source of the powder material so that the electric field oscillates with a frequency of 25 Hz and pulses of powder material are delivered through the mask periodically 25 times each second. The tablet is made to travel past the mask at for example 25 mm/s. The movement of the tablet past the mask causes a series of spots to be developed through the aperture on the tablet with a spacing between the spots of 1 mm as shown in FIG. 3b.

The description above is concerned with the part of the powder coating process in which the pattern is actually applied to the tablet, that being the distinctive part of the process. It will be understood, however, that there will usually be other steps in the process, for example a step of heating the powder to fuse it and secure the pattern to the tablet. In a case where a pattern is to be applied to opposite faces of a tablet, powder may be applied to the first face, that powder fused, the tablet turned over and then powder applied to the second face and fused. Further details of other steps in the process that may be employed are given for example in WO 96/35516, the contents of which are incorporated herein by reference. Whilst that specification shows one particular form of support assembly for supporting and conveying the tablets, it should be understood that other systems could be used. Examples of other conveying arrangements are shown in WO 98/20861 and WO 98/20863, the contents of which are also incorporated herein by reference. Another possible conveying arrangement is one in which the tablets are conveyed along a path disposed in a single plane (which may be horizontal or inclined), travelling through various treatment stations arranged along the path. For example, powder may be applied to one face of the tablet at a first station, the powder fused at a second station, the tablet cooled at a third station, the tablet turned over at a fourth station, powder applied to the opposite face of the tablet at a fifth station, that powder fused at a sixth station and the tablet cooled at a seventh station. Suitable powder coating materials for coating the tablets are described in WO 96/35413 or WO 01/57144, the contents of which are incorporated herein by reference.

1. A method of providing a pattern on a solid dosage form which comprises application of powder material in a pattern to a substrate, the method comprising the steps: providing a mask having an aperture between a source of the powder material and the substrate; applying the powder material to the substrate through the mask; effecting relative movement of the substrate with respect to the source of the powder material during the pattern application process.

2. A method according to claim 1 wherein the position of the mask is fixed relative to the source of the powder material and the substrate is moved past both the mask and the source of the powder material.

3. A method according to claim 1 wherein both the mask and the substrate are moved past the stationary source of the powder material.

4. A method according to claim 1 wherein the thickness of the mask is less than 2 mm.

5. A method according to claim 1 wherein the mask is placed such that the surface of the substrate is less than 2 mm from the surface of the mask during delivery of the powder material.

6. A method according to claim 1 wherein the aperture in the mask is round.

7. A method according to claim 1 wherein the aperture in the mask is a slit whose length is along the direction of relative movement of the substrate.

8. A method according to claim 1 wherein the aperture in the mask is a slit whose length is perpendicular to the direction of relative movement of the substrate.

9. A method according to claim 1 wherein the aperture in the mask is a first slit intersected along its length by one or more further slits that extend transversely to the first slit.

10. A method according to claim 1 wherein the powder material is an electrostatically charged powder material applied by electrostatic means comprising applying a bias voltage to generate an electric field between the source of the powder material and the substrate; applying the electrostatically charged powder material to the substrate, the powder material being driven onto the substrate by the interaction of the electric field with the charged powder material.

11. A method according to claim 10 wherein the bias voltage is a DC voltage and powder is delivered continuously through the mask.

12. A method according to claim 10 wherein the bias voltage is a DC voltage in combination with a high frequency AC voltage and powder is delivered continuously through the mask.

13. A method according to claim 10 wherein the bias voltage is a low frequency AC voltage and powder is delivered periodically through the mask.

14. A method according to claim 10 wherein the magnitude of the bias voltage is varied during application of the pattern.

15. A method according to claim 13 wherein the amplitude of the low frequency AC voltage is varied.

16. A method according to claim 12 wherein the frequency of the bias voltage is varied during application of the powder.

17. A method according to claim 14 wherein the voltage is varied as a constant polarity rectangular wave.

18. A method according to claim 14 wherein the voltage is varied as a constant polarity truncated triangular wave.

19. A method according to claim 17 wherein the electrostatically charged powder material comprises two components, the particles of a first component being of one colour and one charge to mass ratio and the particles of a second component being of a different colour and a different charge to mass ratio, the charge to mass ratios being such that only the particles with the lower charge to mass ratio are driven onto the substrate when the voltage is at its lower value and both component particles are driven onto the substrate when the voltage is at its higher value.

20. A method according to claim 1 wherein the mask is made from an electrically insulating material.

21. A method according to claim 10 wherein the mask is made from an electrically conducting material.

22. A method according to claim 21 wherein the bias voltage between the source of the powder material and the substrate is a DC voltage and an AC or DC blocking voltage is applied to the conductive mask.

23. A method according to claim 10 wherein the mask has a matrix of dot apertures; the circumference of each aperture is electrically conductive; each conductive circumference is electrically insulated from the circumferences of the other dot apertures; and an AC or DC blocking voltage is used to individually address each circumference.

24. A method according to claim 1 further comprising a second application of powder material.

25. A method according to claim 24 wherein the further powder material is applied only to areas of the substrate where powder was not applied in the first application.

26. A method according to claim 1 wherein the substrate to which the powder material is applied is the solid dosage form.

27. A method according to claim 26 wherein powder material is applied to a solid dosage form containing active material.

28. A method according to claim 26 wherein powder material containing active material is applied to a solid dosage form.

29. A method according to claim 1 wherein the powder material is applied to a substrate that is divisible into dosage unit forms.

30. A method according to claim 1 wherein the solid dosage form is an oral dosage form.

31. A method according to claim 1 wherein the solid dosage form is a pharmaceutical dosage form.

32. A method according to claim 31 wherein the pharmaceutical dosage form is a pharmaceutical tablet.

33. A method of applying powder material in a pattern to a pharmaceutical substrate that is divisible into unit dosage forms, the method comprising the steps: providing a mask having an aperture between a source of the powder material and a pharmaceutical substrate; applying the powder material to the pharmaceutical substrate through the mask; and effecting relative movement of the pharmaceutical substrate with respect to both the source of powder material and the mask during the pattern application process.

34. An apparatus for providing a pattern on a solid dosage form by application of powder material in a pattern to a substrate, the apparatus including a source for powder material, a support assembly for supporting the substrate in the vicinity of the source of the powder material, a means for applying the powder material to the surface of the substrate, and a mask with an aperture, the apparatus being arranged such that, in use, the powder material is applied to the substrate through the aperture in the mask.

35. An apparatus as claimed in 34 wherein the mask is fixed relative to the source for powder material and the support assembly for the substrate is mounted for movement relative to both the mask and the source for powder material.

36. An apparatus as claimed in 34 wherein both the support assembly for the substrate and the mask are mounted for movement relative to the source for powder material.

37. An apparatus as claimed in claim 34 wherein the thickness of the mask is less than 2 mm.

38. An apparatus as claimed in claim 34 wherein the mask is positioned such that the surface of the substrate is less than 2 mm. from the surface of the mask during application of the powder material.

39. An apparatus as claimed in claim 24 wherein the aperture in the mask is round.

40. An apparatus as claimed in claim 34 wherein the aperture in the mask is a slit whose length is along the direction of movement of the substrate.

41. An apparatus as claimed in claim 34 wherein the aperture in the mask is a slit whose length is perpendicular to the direction of relative movement of the substrate.

42. An apparatus as claimed in claim 34 wherein the aperture is a first slit intersected along its length by one or more further slits that extend transversely to the first slit.

43. An apparatus as claimed in claim 34 wherein the source for powder material is a source for electrostatically charged powder material and the means for applying the powder material to the surface of the substrate comprises a voltage source for applying a bias voltage between the source for the powder material and the substrate to generate an electric field therebetween, the apparatus being arranged such that, in use, the powder material is driven onto the substrate by the interaction of the electric field with the charged powder material.

44. An apparatus as claimed in claim 43 wherein the voltage source supplies a DC voltage.

45. An apparatus as claimed in claim 43 wherein the voltage source supplies a DC voltage in combination with a high frequency AC voltage.

46. An apparatus as claimed in claim 43 wherein the voltage source supplies a low frequency AC voltage.

47. An apparatus as claimed in claim 43 wherein the source for electrostatically charged powder material is a source for two-component powder material, the particles of a first component being of one colour and one charge to mass ratio and the particles of a second component being of a different colour and a different charge to mass ratio.

48. An apparatus as claimed in claim 43 wherein the mask is made from an electrically insulating material.

49. An apparatus as claimed in claim 43 wherein the mask is made from an electrically conducting material.

50. An apparatus as claimed in claim 49 wherein there is means for applying an AC or DC blocking voltage to the mask.

51. An apparatus as claimed in claim 43 wherein the mask has a matrix of dot apertures; the circumference of each aperture is electrically conductive; each conductive circumference is electrically insulated from the circumferences of the other dot apertures; and means whereby an AC or DC blocking voltage individually addresses each circumference.

52. An apparatus as claimed in claim 34 wherein wherein the substrate to which the powder material is applied is the solid dosage form and the support assembly is a support assembly for supporting a solid dosage form.

53. A solid dosage form that has had a pattern provided on it by a method according to claim 1.
